(19) United States
(12) Patent Application Publication
(10) Pub. No.: US 2017/0096103 A1
(43) Pub. Date: Apr. 6, 2017

(54) REAR CLOSURE OBSTACLE DETECTION SYSTEM FOR A MOTOR VEHICLE

(71) Applicant: FORD GLOBAL TECHNOLOGIES, LLC, Dearborn, MI (US)

(72) Inventor: Claudio Alberto Clamont Bello, Santa Fe (MX)

(21) Appl. No.: 14/873,832

(22) Filed: Oct. 2, 2015

(51) Int. Cl. B60Q 9/00; G01S 15/93; B60J 5/10; G01S 15/04

(52) U.S. Cl. CPC B60Q 9/002; G01S 15/04; G01S 15/931; B60J 5/101

(57) ABSTRACT

A rear closure obstacle detection system is provided for a motor vehicle. The rear closure detection system includes an obstacle detector, an indicator and a controller. The controller is configured to activate the rear obstacle detection system and detect an obstacle to the opening of the rear closure while the motor vehicle is actively being parked.

### TECHNICAL FIELD

This document relates generally to the motor vehicle equipment field and, more particularly, to a rear closure obstacle detection system for a motor vehicle that is active when the motor vehicle is in the process of being parked so as to ensure that the necessary distance is provided to allow opening of the lift gate, hatch or tail gate of the motor vehicle.

### BACKGROUND

Obstruction detection systems for a powered lift gate or other closure provided at the rear of a motor vehicle are well-known in the art. For example, U.S. Pat. No. 6,411,054, owned by Ford Global Technologies, discloses a powered lift gate actuation system specifically adapted to inhibit the opening and/or closing of the lift gate if the vehicle's position is too close to an obstruction and unobstructed movement of the lift gate is not possible.

In the past, obstruction detection systems of this type have been activated only after the motor transmission has been placed in park and the actuator has been triggered to open the lift gate. In those situations where the operator has parked the motor vehicle in such a way as to fail to provide the necessary clearance for the opening of the lift gate, it has then been necessary to restart the vehicle and move the vehicle away from the obstruction.

This document relates to a new and improved rear closure obstacle detection system for a motor vehicle that is functional while parking the vehicle, thereby alerting the user to the potential for such an obstruction which would prevent rear closure operation before the transmission has been placed in park and the motor vehicle has been turned off. Thus, the present rear closure obstacle detection system is more efficient and convenient to use than prior systems limited to operation after the vehicle has been parked, thereby enhancing customer satisfaction.

### SUMMARY

In accordance with the purposes and benefits described herein, a rear closure obstacle detection system is provided for a motor vehicle. That rear closure obstacle detection system comprises an obstacle detector, an indicator and a controller controlled to actuate the rear closure obstacle detector system and detect an obstacle to the opening of the rear closure while the motor vehicle is actively being parked. More specifically, the obstacle detector monitors a swing radius of the rear closure. In one possible embodiment the obstacle detector is a proximity sensor. In one possible embodiment, the indicator is a visual indicator. In one possible embodiment, the indicator is an audio indicator. In one possible embodiment the indicator is a visual indicator and an audio indicator.

In one possible embodiment, the rear closure obstacle detection system further includes a manual switch to activate and/or deactivate the rear closure obstacle detection system.

In one possible embodiment, the controller is configured to activate the rear closure obstacle detection system when the transmission of the motor vehicle is put in reverse.

In accordance with an additional aspect, a method is provided of detecting an obstacle to opening a rear closure of a motor vehicle. That method may be broadly described as comprising the steps of monitoring, by means of an obstacle sensor, a swing radius of the rear closure member while the motor vehicle is actively being parked and indicating, by means of an indicator, if an obstacle is detected.

The method may further include initiating monitoring upon a transmission of the motor vehicle being placed in reverse. Further, the method may include initiating monitoring in response to the triggering of an activation switch.

In addition, the method may include indicating the presence of an obstacle via an audio signal. In another possible embodiment, the method may include indicating the presence of an obstacle via a visual signal on a display console in the motor vehicle. In yet another possible embodiment, the method may include indicating the presence of an obstacle via a visual signal on a rearview mirror of the motor vehicle. In still another possible embodiment, the method may include indicating the presence of an obstacle via an audio signal and a visual signal.

In the following description, there are shown and described several preferred embodiments of the rear closure obstacle detection system. As should be realized, the rear closure obstacle detection system is capable of other, different embodiments and its several details are capable of modification in various, obvious aspects all without departing from the rear closure obstacle detection system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the rear closure obstacle detection system and together with the description serve to explain certain principles thereof. In the drawing figures:

FIG. 1 is a rear elevational view of a motor vehicle equipped with the rear closure obstacle detection system which is the subject matter of this document.

FIG. 2 is a schematic block diagram of the rear closure obstacle detection system.

FIG. 3 is a side elevational view schematically illustrating operation of the closure obstacle detection system as the motor vehicle is actively being parked.

FIG. 4 is a detailed perspective view of a display console in the motor vehicle including a visual indication of a detected obstacle.

FIG. 5 is a view of the rear view mirror including a visual indicator of a detected obstacle.

Reference will now be made in detail to the present preferred embodiments of the rear closure obstacle detection system, examples of which are illustrated in the accompanying drawing figures.

### DETAILED DESCRIPTION

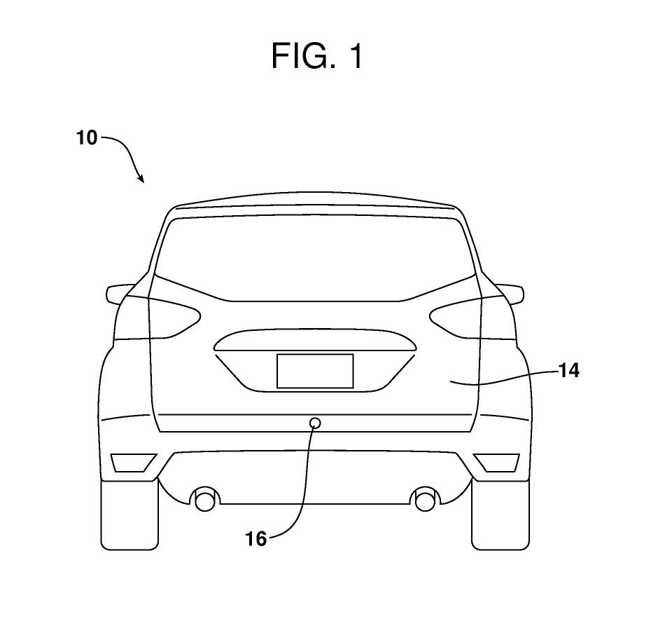

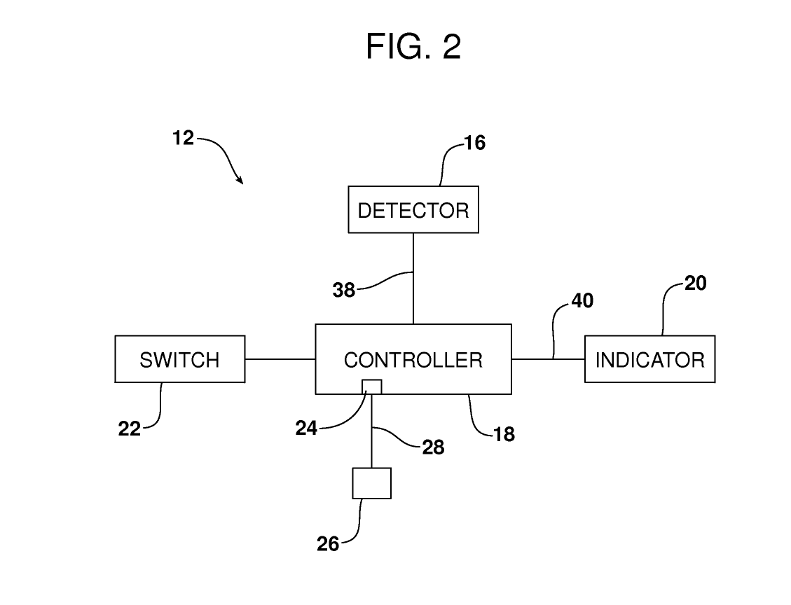

Reference is now made to FIGS. 1 and 2, illustrating a motor vehicle 10 equipped with the rear closure obstacle detection system 12 that is the subject matter of this document. In the illustrated embodiment, the motor vehicle 10 is a sport-utility vehicle (SUV) including a lift gate 14. As should be appreciated, the rear closure obstacle detection system 12 is not limited to use with sport-utility vehicles incorporating a lift gate 14 but in fact may also be utilized for other types of vehicles including other rear closure members such as station wagons and trucks including tail gates and hatchback vehicles including a hatch cover.

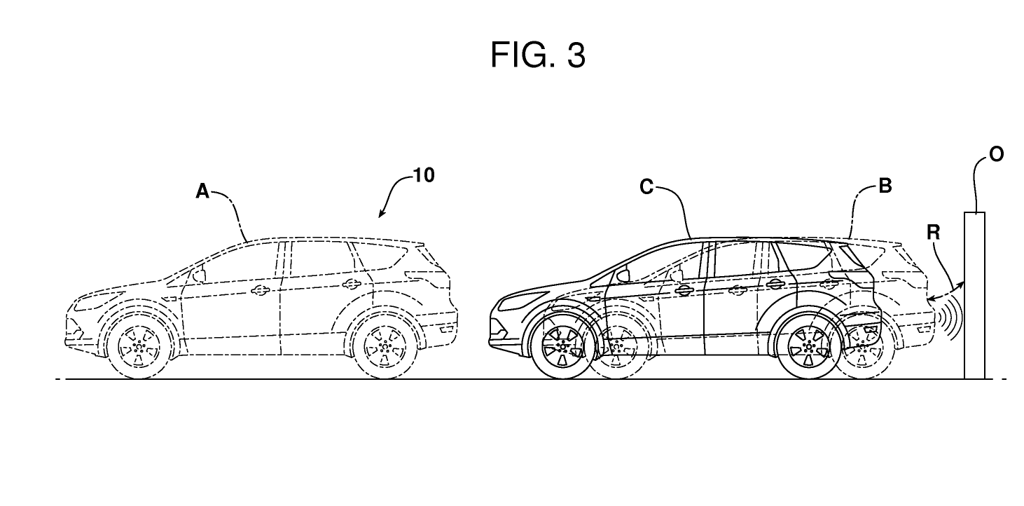

As illustrated, the rear closure obstacle detection system 12 may be broadly described as including an obstacle detector 16, a controller 18, an indicator 20 for indicating detection of an obstacle to the opening and closing of the rear closure member 14 and a manual switch 22 for activating and deactivating the rear closure obstacle detection system. More specifically, the optical detector 16 may comprise a proximity sensor such as a sonar device, an infrared sensor or other appropriate means. Alternatively, the obstacle detector 16 could also comprise a digital camera. As should be appreciated, the obstacle detector 16 as defined in this document may further include multiple sensors/devices as may be required to properly monitor the entire swing radius R of the rear closure member 14 (see also FIG. 3).

The controller 18 is a computing device such as a dedicated microprocessor or electronic control unit (ECU) operating under the direction of appropriate control software. Thus, it should be appreciated that the controller 18 comprises one or more processors, one or more memories and one or more network interfaces that communicate with each other over a communications bus.

As further illustrated in FIG. 2, the controller 18 is configured to include a transmission state input 24 connected to a transmission state sensor, transmission control module or other device 26 that provides a data signal along line 28 respecting the state of the transmission including, more particularly, the gear selected.

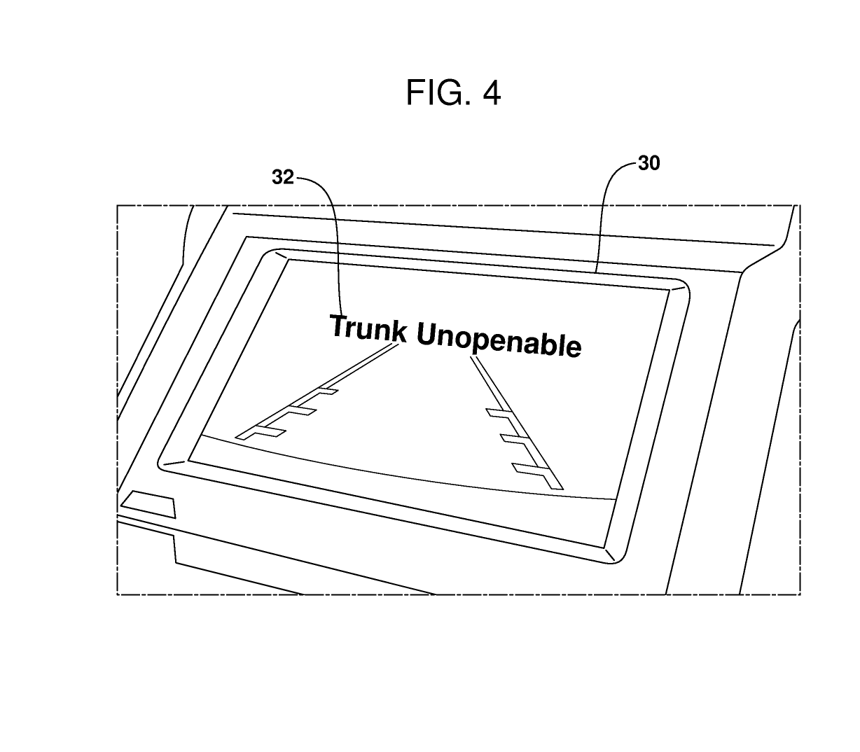

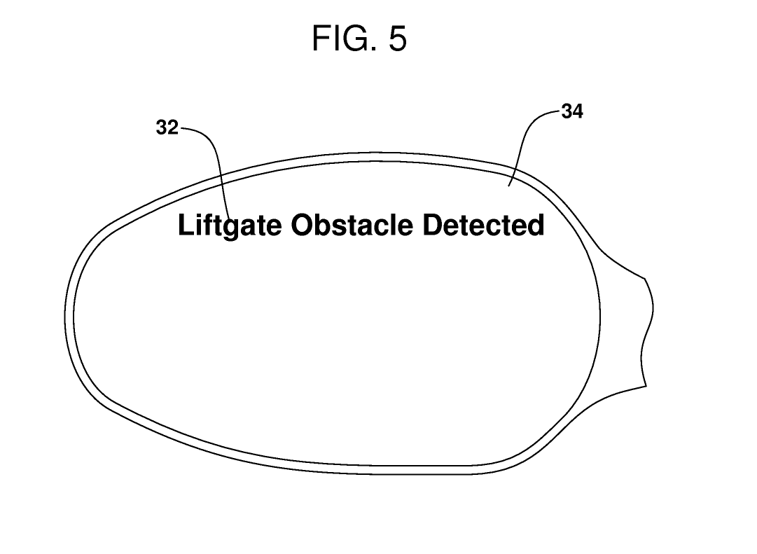

The indicator 20 may be a visual indicator, an audio indicator or both a visual indicator and an audio indicator. Appropriate visual indicators include warning lights or warning messages providing the vehicle operator with a visual indication of the detection of an obstacle in the swing radius R of the rear closure member 14. For example, in FIG. 4 the visual indication 32, “Trunk Unopenable” is provided on a display console 30 of the motor vehicle. In contrast, FIG. 5 illustrates a visual indication 32, “Lift Gate Obstacle Detected” displayed on a rearview mirror 34 of the motor vehicle 10.

Audio indications may include an alarm, buzzer, bell or digital voice message, such as “liftgate obstacle detected”. Such an audio indication should be readily distinguishable from different audio signals that might be used while parking the motor vehicle, such as an audio signal coupled to a proximity sensor used to indicate that the rear bumper of the motor vehicle is about to come into contact with a stationary object.

The manual switch 22 may comprise a pushbutton switch, a toggle switch or any other appropriate switch. Such a switch may, of course, be voice controlled through voice processor capability of the controller 18 or any other appropriate controller provided in the motor vehicle 10 including, for example, the body control module or BCM (not shown).

Reference is now made to FIG. 3 which schematically illustrates the operation of the rear closure obstacle detection system 12. As illustrated, the vehicle operator initially stops the motor vehicle 10 in position A. The operator then puts the transmission in reverse. Device 26 provides an appropriate reverse transmission state data signal along data line 28 to the transmission state input 24 of the controller 18. In response, the controller 18 sends a signal along control line 38 to the obstacle detector 16 which initiates monitoring of the swing radius R of the rear closure member 14 as the motor vehicle is moved in reverse toward the obstacle O. If the motor vehicle 10 is moved toward the obstacle O to the position B, the obstacle detector 16 detects the obstacle within the swing radius R. Thus, an appropriate obstacle detection data signal is then sent from the obstacle detector 16 back to the controller 18 along the control line 38.

In response, the controller 18 sends a control signal along line 40 to provide a visual and/or audio signal 32 indicating the detection of an obstacle in the swing radius R of the rear closure member 14 (note, for example, the obstacle detection signals indicated in FIGS. 4 and 5 on, respectively, the display console 30 and the rearview mirror 34). Upon being provided with the obstacle detection signal, the vehicle operator may stop the vehicle, place the transmission in drive or another forward gear and move the vehicle to position C where sufficient clearance exists between the motor vehicle 10 and the obstacle O to allow the rear closure member 14 to fully open. When the motor vehicle reaches this point, the obstacle detector 16 no longer detects an obstacle O in the swing radius R of the rear closure member 14 and a data signal indicating this change is transmitted to the controller 18 through the control line 38. Controller 18 then responds by sending a control signal along control line 40 to the indicator 20, which terminates the detected obstacle indicator 32. This signals to the vehicle operator that sufficient clearance is now provided for opening the rear closure member 14. Thus, the operator may then shift the transmission of the vehicle into park, shut off the ignition switch, and activate the automatic rear closure member opening system.

It should be appreciated that the controller 18 and the obstacle detector 16 may be configured in such a way that once an obstacle O is detected within the swing radius R by the obstacle detector 16, the obstacle detector 16 will continue to monitor the swing radius R until the obstacle O is no longer within the swing radius. Thus, the operation of the obstacle detector 16 is simultaneously dependent on the transmission state, the detection of an obstacle O and/or any other appropriate input.

As should be appreciated from the foregoing, the rear closure obstacle detection system 12 is characterized by a method of detecting an obstacle to opening the rear closure member 14 of a motor vehicle 10, which comprises the steps of monitoring, by means of an optical sensor or detector 16, a swing radius R of the rear closure member 14 while the motor vehicle 10 is actively being parked and indicating, by means of an indicator 20, if an obstacle is detected. As described in the foregoing, that method may include initiating monitoring upon a transmission of the motor vehicle 10 having been put in reverse. Alternatively, the method may include initiating monitoring in response to an activation switch 22. Further, the method may include indicating the presence of the obstacle in the swing radius of the rear closure member 14 via a audio signal, a visual signal or an audio and a visual signal together. As noted in FIG. 4, the visual signal may be provided on a display console 30 of the motor vehicle 10 and/or on a rearview mirror 34 of the motor vehicle.

In summary, the rear closure obstacle detection system 12 and its related method of operation provide a number of benefits and advantages. Significantly, a vehicle operator is informed when the necessary clearance for the opening of the rear closure member 14 is provided while the motor vehicle 10 is actively being parked. This represents a significant benefit and advantage over rear closure obstacle detection systems of the prior art which only functioned when the system for automatically opening the rear closure member was activated which occurred after the motor vehicle ignition was shut off and often after the operator had left the driver's seat and gone to the rear of the vehicle. As should be appreciated, where the driver did not leave the necessary clearance for the opening of the rear closure member in the prior art systems, the driver had to restart and move the vehicle as necessary. The current obstacle detection system 12 avoids this potential inconvenience to the satisfaction of the vehicle operator.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A rear closure obstacle detection system for a motor vehicle having a rear closure, comprising:
an obstacle detector;
an indicator; and
a controller configured to actuate said rear closure obstacle detection system and detect an obstacle to opening of said rear closure while said motor vehicle is actively being parked, wherein said controller is configured to activate said rear closure obstacle detection system when a transmission of said motor vehicle is put in reverse.

2. The rear closure obstacle detection system of claim 1, wherein said obstacle detector monitors a swing radius of said rear closure.

3. The rear closure obstacle detection system of claim 1, wherein said obstacle detector is a proximity sensor.

4. The rear closure obstacle detection system of claim 1, wherein said indicator is a visual indicator.

5. The rear closure obstacle detection system of claim 1, wherein said indicator is an audio indicator.

6. The rear closure obstacle detection system of claim 1, wherein said indicator is a visual indicator and an audio indicator.

7. The rear closure obstacle detection system of claim 1, further including a manual switch to activate and/or deactivate said rear closure obstacle detection system.

8. (canceled)

9. A method of detecting an obstacle to opening a rear closure of a motor vehicle, comprising:
monitoring, by means of an obstacle sensor, a swing radius of said rear closure member while said motor vehicle is actively being parked; and
indicating, by means of an indicator, if an obstacle is detected.

10. The method of claim 9, including initiating monitoring upon a transmission of said motor vehicle being put in reverse.

11. The method of claim 9, including initiating monitoring in response to an activation switch.

12. The method of claim 9, including indicating the presence of an obstacle via audio signal.

13. The method of claim 9, including indicating presence of an obstacle via visual signal on a display console in said motor vehicle.

14. The method of claim 9, including indicating presence of an obstacle via visual signal on a rear view mirror of said motor vehicle.

15. The method of claim 9, including indicating the presence of an obstacle via an audio signal and a visual signal.

16. The method of claim 9, including continuing to monitor the swing radius of said rear closure member until the obstacle is no longer detected.
